(19) United States
(12) Patent Application Publication
(10) Pub. No.: US 2008/0105839 A1
(43) Pub. Date: May 8, 2008

(54) FLOW CONTROL SYSTEMS AND CONTROL VALVES THEREFOR

(75) Inventors: Jeffrey D. Jennings, Hendersonville, NC (US); Franz W. Kellar, Gastonia, NC (US)

Correspondence Address: TREGO, HINES & LADENHEIM, PLLC, 9300 HARRIS CORNERS PARKWAY, SUITE 210, CHARLOTTE, NC, 28269-3797, US

(73) Assignee: INSIGHT PROCESS SOLUTIONS, LLC, Hendersonville, NC (US)

(21) Appl. No.: 11/868,781

(22) Filed: Oct. 8, 2007

Related U.S. Application Data
(60) Provisional application No. 60/828,657, filed on Oct. 8, 2006.

(51) Int. Cl. F16K 31/12; F16K 27/00

(52) U.S. Cl. 251/61.1; 137/1; 251/366

(57) ABSTRACT

A fluid system, a control valve therefor, and a method of its operation are provided. The fluid system includes a piping run, and a control valve which includes: a housing having an inlet connected to the piping run, an outlet connected to the piping run, and a pressure port; and a elastomeric tube disposed inside the housing, the tube having a flow passage extending therethrough which is in fluid communication with the inlet and outlet. An outer surface of the tube and the housing cooperatively define a pressure chamber which is in fluid communication solely with the pressure port, A source of controlled fluid pressure is connected to the pressure port to modulate flow in the tube. The tube is sized and the valve is operated so as to provide accurate flow rate control.

### CROSS-REFERENCE TO RELATED APPLICATIONS

This application claims the benefit of Provisional Application No. 60/828,657, filed Oct. 8, 2006.

### BACKGROUND OF THE INVENTION

This invention relates generally to fluid systems, and more particularly to flow control valves and methods of operation.

Accurate flow rate control is required in order to successfully achieve many commercially important processes involving liquid transport. For example, accurate, steady delivery flow rate is required in precision pre-metered coating processes. Flow rate control is typically achieved with a form of positive displacement (“PD”) pump or a metering valve. While a PD pump has the advantage of not requiring a flow meter, there are also many potential disadvantages, such as persistent pulsation, rotating seals that can leak, zones of high shear, viscosity dependency, flow rate drift, and mechanical complexity.

Flow rate control achieved via the action of a control valve operated with a control system as is generally well known in the art. Such systems typically employ a source of constant pressure upstream of the control valve, such as a “pressure pot” or “pressurized vessel”. In each of these, a volume of compressible gas is useful above the liquid to help dampen out pulsations, which would disrupt the steady state process (especially precision coating operations).

Conventional control valves usually have a seat with stem and stem seal. Because of limitations in the seat and stem geometry, precise flow control cannot be achieved when the stem seal nearly closes the seat, which occurs below about 10% of full flow range. Accordingly, the valve seat is typically designed to control flow precisely in a relatively narrow dynamic range of approximately 10:1 valve coefficient (Cv), or flow, or less. Furthermore, the moving stem and stem seal have friction which make it difficult for typical control valves to resolve flow rates less than 1% of full flow range. Often, a valve which is controlled by an air signal requires a complex and expensive “positioner” to minimize the position hysteresis caused by valve friction. For these reasons, typical control valves are sized to perform in a liquid flow range of 10:1 maximum, with precision performance in a range closer to 5:1. In other words, these conventional valves cannot effectively control flow rates below 10% of full flow range and even in the controllable range, they cannot resolve the flow to better than about 1% of full flow range. Further, valves of this construction are typically not available or sized for flow rates below 10 ml/min.

Conventional control valves exhibit additional deficiencies. A conventional valve seat presents a relatively small flow area and a correspondingly small region of high liquid velocity and intense shear that is necessary to produce the pressure drop required for the valve to modulate flow rate. However, this intense shear is problematic for many industrially-important shear-vulnerable liquids such as latex suspensions and biological fluids which contain cells or dispersions or emulsions which may be damaged by local regions of high shear. Moreover, the high velocity at the valve seat corresponds with low pressure similar to that occurring in the vena contracta of a venturi flow and this low pressure can result in liquid cavitation in certain cases. Such cavitation can lead to bubble defects in certain applications, such as medical devices or coating systems. Additionally, conventional control valves have stem seals that often seal along a sliding surface, allowing for the possibility of liquid leaks. Finally, typical control valves have complex internal geometries which present numerous crevices which are difficult to clean and flush and can thereby result in cross contamination and the retention of unwanted bubbles.

Another type of control valve that is occasionally used is a pinch valve. In this valve a short length of elastomeric conduit in the flow path is constricted (“pinched”) by some means which increases pressure drop through the conduit, thereby controlling the flow rate. The internal flow passage of the conduit is continuous and smooth and therefore crevices are avoided and therefore hygienic flow applications are possible. Furthermore, the liquid contacts only the internal flow surface of the elastomeric conduit. Consequently, pinch valves can be utilized with liquids containing particulates such as abrasives and also corrosives, both of which are potentially problematic with conventional control valves having stems, stem seals and seats as described previously.

One type of pinch valve that is capable of controlling flow rate constricts the conduit with a linear actuator connected to a pressing block in a manner similar to globe-style control valve. However, similar to the conventional control valve with a stem and seat, the resolution and hysteresis performance of these valves is limited by the friction in the mechanism, and the dynamic flow range for good control is limited by the mechanics of the pinching device and the geometry of the pinched elastomeric conduit.

Another type of pinch valve is an air pinch valve. This is an valve in which a short segment of elastomeric conduit is constricted by external pressure, usually applied via a surrounding air pressure chamber. Other fluids can easily function as the pinch fluid. FIG. 1 illustrates a prior art pinch valve 10 which includes a rigid housing 12 carrying an elastomeric tube 14 which is connected to an inlet 16 and an outlet 18. This pinch valve 10 has a complex, nonlinear characteristic response curve because air collapses the tube 14 into a geometry having a cross-section shape with an elongated center and bulbous ends resembling a dog bone, as shown in FIG. 2A. Modulating the flow at or near to the threshold pressure for a collapsed tube tends to open and/or close the “dog bone” configuration, as depicted in FIG. 2C. This results in large changes of the flow caused by very small changes in applied pinch pressure. The valve flow response is hypersensitive and thus the pinch valve 10 cannot precisely control flow rate.

Although this hypersensitivity has prevented pinch valves from being utilized for typical flow rate control applications, they are used with great utility for on-off flow service. In commercially-available air pinch valves the shape of the elastomeric conduit is optimized to accentuate this tube collapse mechanism. For example, FIG. 3 illustrates a pinch valve 50 in which the wall thickness of a molded tubing insert 52 is tapered from being very thick where it contacts the end flanges 54 of its housing 56 to a thin, short segment 56 at the center of the pinch valve 50. This concentrates the pinching action at this most vulnerable central segment 56.

In addition to flow metering applications, the chemical industry uses injector valves to facilitate mixing of incompatible or reactive chemicals together. If the smaller fluid stream (“minor component” or “injectant”) serves to catalyze or harden the larger fluid stream (“major component”), the minor component must be introduced in a very specific way. Such examples are found through the polymer industry, including for example photographic emulsion coating, but also biological processes such as blood streams where an injected component may accelerate a form of biological growth. In these situations, it is imperative that the two chemicals are introduced into a high shear zone of the flow to avoid forming particles or gels in the stream.

Steady state injection systems suffer from difficulty in controlling the interface between the reactive components, especially as the flow rate of the minor injectant is reduced and/or intermittently stopped. Any reduction in the velocity of the minor injectants can result in hardened or gelled build-up on the equipment at the interface of the fluids. Conventional valve and tee designs do not provide a satisfactory interface, as any dead space (especially with an aspect ratio greater than 1 L/D, where L is the length of the dead space and D is the internal diameter) between the sealing point and the open stream of the major fluid can result in build-up. Spring loaded check-type interface injector valves are sometimes used to control the interface, but are notorious for becoming plugged or stuck open. The failure mechanism is that initially minute leakage through a conventional seal results in additional hardened material in the seal zone, contributing to a rapid failure. Actuated style globe or ball valves can provide acceptable service if designed to present the seal very close to the main fluid stream. However, if the actuated valve remains open during any period of very low or zero flow, the valve and upstream conduits are often contaminated with hardened materials. The actuated valve design also fails to present high velocities (high shear rates, and high Reynolds numbers) of the injectant into the major component in order to effect thorough mixing.

### BRIEF SUMMARY OF THE INVENTION

These and other shortcomings of the prior art are addressed by the present invention, which provides a control valve and a method for its use. The control valve has an elastomeric tube that is elongated relative to its inner diameter and correspondingly elongated in comparison with the elastomeric tubes of conventional air pinch valves. The elongated elastomeric tube, when constricted by applied pinch pressure, provides an internal passage whereby the pressure drop necessary to effect flow rate control is smoothly and gradually distributed along the conduit's elongated length. A method for using the control valve includes a sizing of the elastomeric tube such that a substantially larger cross section is employed than would be specified with conventional tubing system design. The method further includes providing an effective control logic for operating the control valve. The method further includes minimizing the pinch pressure required for control and thereby enhancing control stability via appropriate design of the entire flow system. The control valve precisely and stably controls flow rate over an extremely large dynamic range, and is highly suitable for low flow rates below 5 ml/min down to and below 0.1 ml/min. It also exhibits many other advantages over conventional control valves. The control valve can also be used to control an injection process.

According to an aspect of the invention, a method of controlling flow in a fluid system includes: (a) providing a control valve including: a housing having an inlet, an outlet, and a pressure port; and a elastomeric tube disposed inside the housing, the tube having a flow passage extending therethrough which is in fluid communication with the inlet and outlet. An outer surface of the tube and the housing cooperatively define a pressure chamber which is in fluid communication solely with the pressure port. The control valve, when the tube is in a relaxed state, has a maximum valve coefficient at a selected pressure drop across the control valve. (b) passing pressurized fluid through the flow passage from the inlet to the outlet at the selected pressure drop; and (c) modulating the flow rate through the flow passage by applying fluid pressure to the pressure chamber through the pressure port so as to deform the tube, the flow rate selected such that the valve coefficient of the control valve in operation is less than about 0.1% of the maximum valve coefficient.

According to another aspect of the invention, a control valve includes: a housing having an inlet, an outlet, and a pressure port, the inlet and outlet having a first inside diameter; and a elastomeric tube disposed inside the housing, the tube having a flow passage extending therethrough which is in fluid communication with the inlet and outlet. An outer surface of the tube and the housing cooperatively define a pressure chamber which is in fluid communication solely with the pressure port. The flow passage has a second inside diameter which in a rest state is substantially greater than the first inside diameter.

According to another aspect of the invention, a control valve includes: (a) a housing having an inlet, an outlet, and a pressure port, the housing having outward-facing inner seats disposed at opposite ends thereof, (b) a elastomeric tube disposed inside the housing, the tube having a flow passage extending therethrough which is in fluid communication with the inlet and outlet; (c) wherein an outer surface of the tube and the housing cooperatively define a pressure chamber which is in fluid communication solely with the pressure port; and (d) means for compressing the tube against the sealing surface so as to isolate the pressure chamber from flow communication with an exterior environment except through the pressure port.

According to another aspect of the invention, a fluid injector includes: (a) a tee block having intersecting first and second flow passages therein; and (b) a control valve connected in fluid communication with the second passage, the control valve including: a rigid housing; and an elastomeric tube disposed inside the housing, the tube having a flow passage extending therethrough disposed in fluid communication with the second passage, where a termination of the tube is located within about 1 inner diameter of the tube or less from an intersection between the two passages.

According to another aspect of the invention, a control valve includes: (a) a housing having an inlet, an outlet, and a pressure port; and (b) a elastomeric tube disposed inside the housing, the tube having a flow passage extending therethrough which is in fluid communication with the inlet and outlet, and having a cross-sectional shape comprising a plurality of radially-extending lobes. An outer surface of the tube and the housing cooperatively define a cavity which is in fluid communication solely with the pressure port.

### BRIEF DESCRIPTION OF THE DRAWINGS

The invention may be best understood by reference to the following description taken in conjunction with the accompanying drawing figures in which:

FIG. 1 is a schematic cross-sectional view of a prior art control valve;

FIG. 2A is a schematic cross-sectional view of tube of a prior art pinch valve in a stable state with medium-to-high flow rate;

FIG. 2B is a schematic cross-sectional view of tube of a prior art pinch valve in a stable state with a low flow rate;

FIG. 2C is a schematic cross-sectional view of tube of a prior art pinch valve in a hypersensitive state with a high flow rate;

FIG. 3 is a schematic cross-sectional view of a prior art pinch valve which is optimized for “on-off” operation;

FIG. 4 is a cross-sectional view of an exemplary control valve constructed according to an aspect of the present invention;

FIG. 5 is a cross-sectional view of an alternative control valve;

FIG. 6 is a cross-sectional view of another alternative control valve;

FIG. 7 is a cross-sectional view of another alternative control valve;

FIG. 8 is a cross-sectional view of yet another alternative control valve;

FIG. 9 is a cross-sectional view of an exemplary elastomeric tube for use with a control valve;

FIG. 10 is a cross-sectional view of an alternative elastomeric tube;

FIG. 11 is a schematic diagram of a fluid system utilizing a control valve constructed according to the present invention;

FIG. 12 is a graph showing typical air pinch pressure versus flow;

FIG. 13 is a logarithmic plot of the data in FIG. 12;

FIG. 14 is a sensitivity curve derived from the data of FIG. 12;

FIG. 15 is a graph showing an example of an adaptive gain multiplier curve resulting from the sensitivity curve of FIG. 14;

FIG. 16 is a perspective view of an exemplary fluid injector constructed according to the present invention; and

FIG. 17 is a cross-sectional view of the injector of FIG. 16.

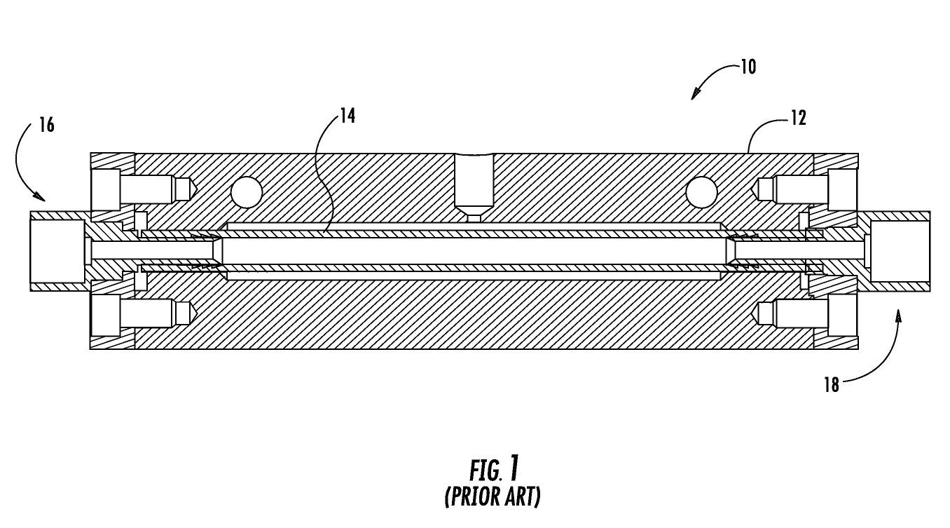

### DETAILED DESCRIPTION OF THE INVENTION

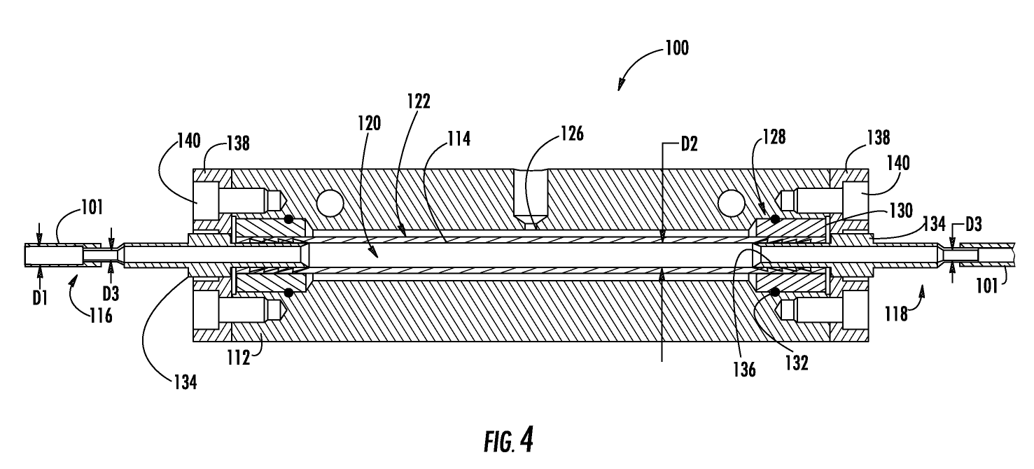

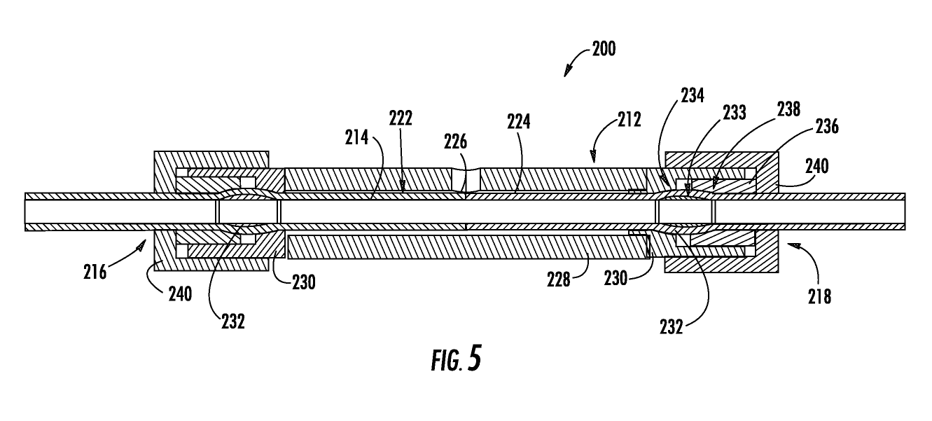

Referring to the drawings wherein identical reference numerals denote the same elements throughout the various views, FIG. 4 illustrates an exemplary control valve 100 constructed in accordance with an aspect of the present invention. The control valve 100 is similar to the prior art control valve 10 and has a rigid, generally cylindrical housing 112 with an inlet 116 and an outlet 118. An elastomeric tube 114 passing through the housing 112 has a flow passage 120 extending therethrough. The outer surface 122 of the tube 114 and the interior of the housing 112 cooperatively define a pressure chamber 124. A pressure port 126 in the sidewall of the housing 112 is in fluid communication with the pressure chamber 124.

A counterbore 128 is formed at each end of the housing 112. A cylindrical collar 130 is received in each counterbore 128 and surrounds the tube 114. The collars 130 are sealed to the housing 112 with O-rings 132 or other suitable seals. A fitting 134 with a barb 136 is inserted into each of the distal ends of the tube 114 such that the tube 114 is compressed between the collar 130 and the fitting 134. An end cap 138 is attached to each end of the housing 112 and retains the respective collar 130 and fitting 134, for example using the illustrated screws 140, other kinds of fasteners, adhesives, or thermal or sonic bonding.

The tube 114 in this example is about 6.4 mm (¼ in.) inside diameter (ID), 1.6 mm ( 1/16 in.) wall thickness tubing of 61 Shore-A NORPRENE thermoplastic elastomer. The constrictable length of the tube 114 is about 11.4 cm (4½ in.) inches long and about 6.4 mm (¼ in.) interior diameter. While this control valve 100 is capable of modulating flow below about 0.1 ml/min. and up to approximately 10,000 ml/min., it is the lower end of this flow range which is a preferred operating range. The tubing outside diameter (OD) in this example is chosen for practical considerations. The tubing could be larger or smaller to satisfy fluid velocity considerations. The surrounding pressure chamber 124 is preferably sized such that a completely collapsed (flattened) tube 114 is contained with little or no distortion provided by the interior of the housing. The tube 114 may be made from any flexible elastomer (e.g. rubber or thermoplastic elastomer). A Shore A hardness of between about 30 and about 90 is preferred. The most preferred embodiment is a Shore A hardness in the range of about 50 to about 70 Shore A Durometer. Tubing of 61 Shore A NORPRENE thermoplastic elastomer or 65 Shore A VITON are examples of suitable tubing. Other noncylindrical shape conduits can be used. The wall thickness is an important parameter for minimizing required overpressure in a practical design. The tube 114 should be flexible enough so that excessive pinch pressure is not required, not so flexible that it crushes too easily, as low air pinch pressures are difficult to regulate in a stable fashion. and should be in the range of about 0.8 mm ( 1/32 in.) to about 6.4 mm (¼ in.) for most applications for tubing in the 30 to 90 Shore A Durometer range. For tubing in the 50 to 70 Shore A Durometer, the wall thickness of about 1.6 mm ( 1/16 in.) would be appropriate for applications where the available air pinch pressure is approximately 20-40 psi greater than the incoming fluid pressure.

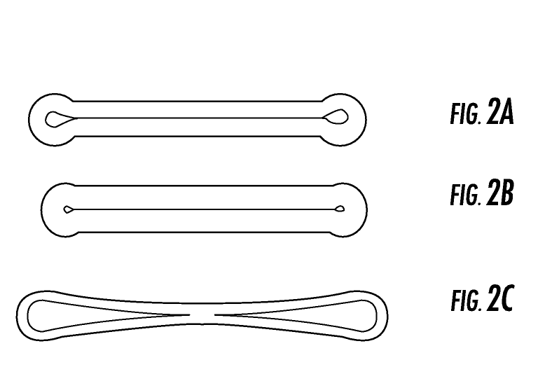

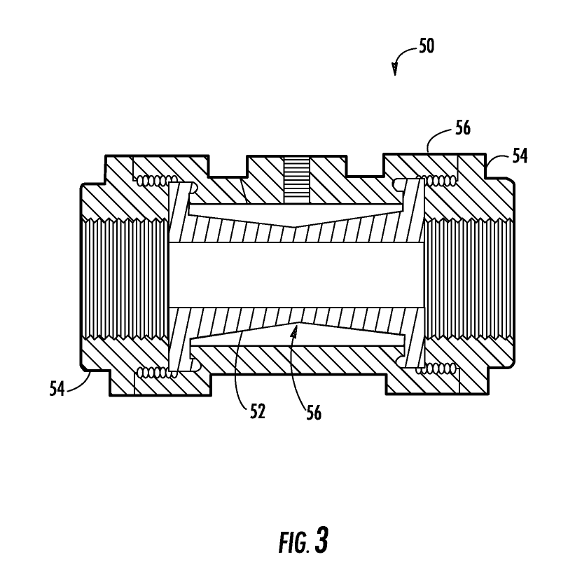

The control valve 100 constructed this way can be characterized by having a full shut-off pinch overpressure of approximately 1.76 kg/cm² (25 psi), i.e. the air pinch pressure exceeds the inlet liquid supply pressure by 1.76 kg/cm² (25 psi). Very slight increases in wall thickness would be expected to increase shut-off overpressure value significantly (classically to the third power according to beam stiffness theory). Changes in extension and compression modulus of the elastomer (implied by Shore A Durometer) would be expected to impact air pinch overpressure linearly. Accordingly, a 6.4 mm (¼ in.) wall thickness tubing may be selected if it were convenient to supply very high pinch pressures, for example more than about 7.0 kg/cm² (100 psi). However, industrial and laboratory settings typically work with air pressures less than 7.0 kg/cm² (100 psi). While the absolute wall thickness appears to govern the behavior of the tube 114 at the low end of valve opening (low Cv), the wall thickness to internal diameter ratio is another factor which appears to govern the behavior of the tubing as the “dog-bone” shape begins to open up towards the unstable zone depicted in FIG. 2C. A wall thickness to ID ratio between about 1:2 and about 1:8 results in a valve with stable sensitivity curve capable of controlling a wide flow range. A preferred ratio is approximately 1:4. Accordingly, a wall thickness in the range of about 0.8 mm ( 1/32 in.) to about 6.4 mm (¼ in.) is appropriate for most industrial and medical applications with materials in the Shore A Durometer 30 to 90 range.

The length of the exposed elastomeric tube 114 is another important design element. In order to minimize the shear rate inside the control valve 100 for critical services, the unreinforced portion of the tube 114 should have several diameters' length. Considering that the end-effects of the barb 136 consume at least one inner diameter on each end, the unreinforced length of the tube 114 is preferably at least 4 inner diameters to minimize shear. As shown in FIG. 4, approximately 16 inner diameters are exposed. It is presumed that the maximum shear rate continues to decline with increasing length of exposed tubing.

The housing 112 is entirely non-wetted and consequently the housing 112 may be fabricated of any desired and structurally suitable material such as steel, aluminum, brass, or rigid polymer. Examples of suitable materials include 316 Stainless steel and DELRIN polymer. The pressure port 126 preferably has a small diameter, for example about 3.2 mm (⅛ in.), to minimize the area of unsupported tubing (in event of overpressure of the tube 114). The housing 112 may be partially or fully transparent so that the pinching of the tube 114 in operation is visible to the user. The tube 114 may also partially or fully transparent so that the fluid therein and any bubbles are visible to the user.

The collar 130 is also non-wetted and may be fabricated from any suitable material, such as those mentioned above for the housing 112. The collar ID should be sized to provide for very strong compression of the tube 114 between it and the barb 136. A preferred embodiment is for the collar ID to be approximately the same diameter as the OD of the tube 114. The length of collar and barb engagement of the tube 114 should be sufficient to secure the tube 114 with no risk of disconnection. A preferred embodiment of the invention has the barb/outer constraint engagement for approximately two outer diameters of the tube 114. The fitting 134 should be suitable for the selected tubing ID and convert to the desired liquid end connection for the control valve 100. A wide selection of commercial hose barb adaptors are available. Commercial adaptors from barb to both female NPT and tube stub ends are both suitable examples. Custom barb adaptors may also be fabricated if necessary or desired. The barb/collar combination should place the tube 114 into strong compression at one or more locations along the length of engagement, as do conventional barb fittings. For example, a minimum clearance between the barb 136 and the collar 130 of approximately 50% of the normal tube wall thickness is suitable.

In an alternate configuration, the housing 112 may be configured similar to the prior art pinch valve 10 without separable collars. Instead, the housing 112 would be machined to mimic the dimensions of the installed collars (in other words, the interior of the housing 112 would have an undercut configuration). No O-ring would be required in this embodiment. This embodiment would have the same functional geometry as discussed above.

The barb 136 must be inserted into the tube 114 without having the tube 114 slip into the interior of the housing 112. One method of accomplishing this task is to pull an over-sized length of the tube 114 about 1 to 1.5 outer diameters out of the housing 112. The friction against the barb 136 can optionally be reduced by wetting the barb 136 with water or appropriate liquid. The barb 136 is then inserted about half of its length into the tube 114 before engaging with the collar 130. The barb 136 is inserted the rest of the way into the tube 114 with a circular motion that controls the slippage of the tube 114 against the housing 112. For the second end, the tube 114 is trimmed flush to the housing 112, or very slightly (e.g. ⅓ outer diameter) protruding. The tube 114 is elongated out of the housing by 1 to 1.5 diameters and the procedure above is repeated.

The control valve 100 described above may be fabricated using commercially available tubing instead of pre-molded elastomeric components. One of the advantages to this is the wider selection of commercially available tubing, with the full spectrum of Shore A hardness, color, transparency, chemical resistance, sterility, and thickness. Another potential advantage is the use of the increased pinch length to reduce the relative shear rate in the fluid, compared with shorter pinch lengths at the same pressure and flow conditions. However, conventional tubing lacks special retention features such as flanges and lips, and a method of retaining and sealing the tubing in the valve housing must be provided. Several possible methods for achieving this will now be described.

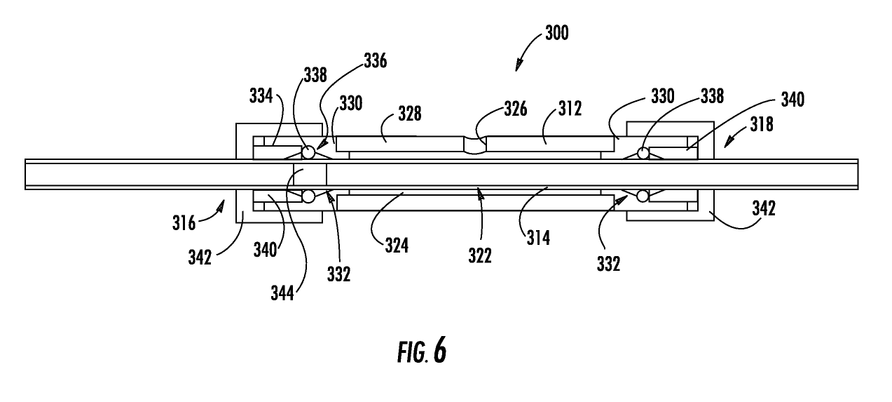

FIG. 5 illustrates an exemplary control valve 200 similar in construction to the control valve 100 described above. The control valve 200 includes a housing 212 with an inlet 216 and an outlet 218, a pressure port 226, and an elastomeric tube 214 passing through the housing 212. The outer surface 222 of the tube 214 and the interior of the housing 212 cooperatively define a pressure chamber 224 which is in fluid communication with the pressure port 226.

The tube 214 is uninterrupted as it traverses through the housing 212. This is appropriate for low pressure applications where the inlet fluid pressure is not greater than the tube's pressure rating. The housing 212 shows an optional construction in which a center section 228 and two outer sections 230 are fabricated separately and joined through any suitable means. At each end of the tube 214, a rigid ferrule 232 is disposed inside the tube 214. The ferrules 232 may be slipped into the tube 214 by the use of some lubricated inner rod (not shown). The ferrule 232 presents a convex-configured outer surface 233 which may be contoured, radiused, or angled.

The housing 212 includes an inner seat 234 at each end which has surfaces that receive the tube 214 as it is stretched around the ferrule 232. The inner seat 234 may have a conical surface as shown. A retainer 236 is placed around the tube 214 and has an outer seat 238 which is designed to contact the outer surface 222 of the tube 214 as it is stretched around the ferrule 232 (again, a conical surface may be used as shown). These seats on both the retainer 236 and the housing 212 are designed to that the thrusting of the retainer 236 forward towards the housing 212 increasingly compresses the wall of the tube 214 between the ferrule surface and the outer seat 238 and between the ferrule surface and the inner seat 234, thereby affecting the constraint of the tube 214 and the required seal between the pressure chamber 224 and the exterior environment. This retainer 236 may be stabilized by some form of contact with the housing 212 so that its movement is constrained in the axial direction. In the illustrated example the retainer 236 is inserted into a female cavity of the housing 212 to constrain its motion.

Optionally, the retainer 236 may include a male or female feature which is received by the opposite gender feature on the housing 212 to prevent the retainer 236 from rotating inside the housing 212. A means of thrusting the retainer 236, such as the illustrated cap 240, is required. The cap 240 may be threaded on the housing 212 or retained with fasteners, adhesives, welding, or the like. A spring washer or other compressible device (not shown) may optionally be used between the retainer 236 and the thrusting means as a means of further insuring compression of the tube surfaces. The sealing of this design is accomplished by the outer surface 233 of the ferrule 232 compressing the tube 214 against the seats 234 and 238. The fluid experiences very little disruption, with a very cleanable, hygienic ferrule 232. The design of the receiving surfaces is preferably done so that the compression of the tube 214 extends very close to the wetted end of the ferrule 232 in order to prevent any wetted crevices.

FIG. 6 illustrates another pinch valve 300 similar in construction to the control valve 200 described above, including a housing 312, with an inlet 316, an outlet 318, and a pressure port 326, and an elastomeric tube 314 passing through the housing 312. The outer surface 322 of the tube 314 and the interior of the housing 312 cooperatively define a pressure chamber 324 which is in fluid communication with the pressure port 326. The illustrated housing 312 shows an optional construction in which a center section 328 and two outer sections 330 are fabricated separately and joined through any suitable means.

The housing 312 includes an inner seat 332 at each end in the form of a counterbore 334 terminating in a shoulder 336. An O-ring 338 or exterior ferrule (such as an instrument fitting ferrule with or without a reinforcing inner sleeve) is placed against the shoulder 336 and around the tube 314. A generally cylindrical retainer 340 is placed around the tube 314. Longitudinal thrust against the retainer 340 (such as that applied by the illustrated cap 342) squeezes the O-ring 338 against the shoulder 336 and compresses the tube 314 to effect a seal between the housing 312 and exterior environment as well as the tube 314 and the housing 312. Such compression forces could be applied with or without an optional rigid internal ferrule 344 placed inside the tube 314.

In addition to the configurations described above, other methods of using continuous tubing to create a practical control valve are possible. For example, a thermal, chemical, or adhesive seal could be used to bond a section of tubing to the ends of cylindrical housing. No collar structure as described above would be needed.

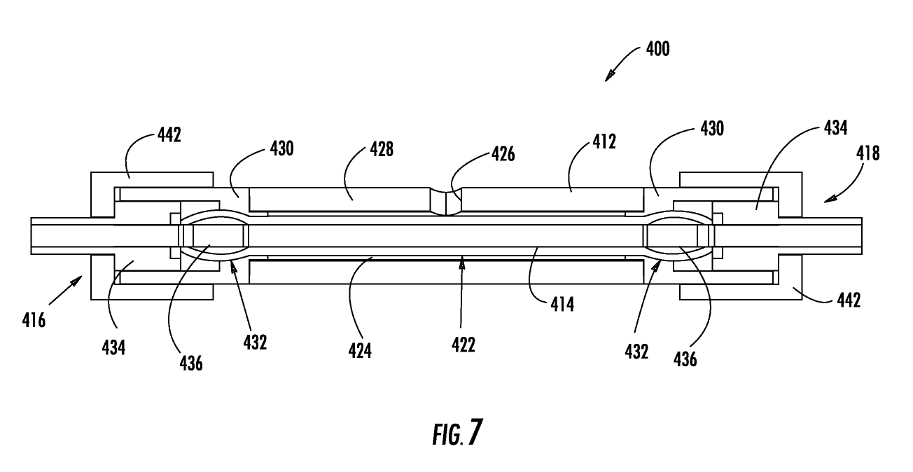

FIG. 7 illustrates yet another exemplary control valve 400 similar in construction to the control valve 200 described above. The control valve 400 includes a housing 412 with an inlet 416 and an outlet 418, a pressure port 426, and an elastomeric tube 414 passing through the housing 412. The outer surface 422 of the tube 414 and the interior of the housing 412 cooperatively define a pressure chamber 424 which is in fluid communication with the pressure port 426. The housing 412 shows an optional construction in which a center section 428 and two outer sections 430 are fabricated separately and joined through any suitable means. The housing 412 includes an inner seat 432 at each end which has surfaces that receive the tube 414. The inner seat 432 may have a conical surface as shown.

At each end, a fitting 434 is provided including a barb 436 inserted into the tube 414. The barb 436 is similar to the ferrule 232 described above and presents a convex-configured outer surface that may be contoured, radiused, or angled. The inner seat 432 is designed to that the thrusting of the fitting 434 forward towards the housing 412 increasingly compresses the wall of the tube 414 between the barb's outer surface 438 and the inner seat 432 of the housing 412. Opposite the barb 436, the fitting 434 has some form of fluid connector, which could be any form of fluid connector known in the medical, laboratory, or industrial sector. Examples are a tube stub (shown), male or female threaded fittings, instrument fittings, sanitary fittings, luer or other type of medical fittings, fittings using ferrules of any kind, etc. The fitting 434 preferably contains a feature that provides mechanical stability relative to the housing. In the illustrated example, the exterior surface of the fitting 434 is received by an interior surface of the housing 412 to constrain motion to the axial direction.

Optionally, the fitting 434 may include a male or female feature which is received by the opposite gender feature on the housing 412 to prevent the retainer 434 from rotating inside the housing 412. A means of thrusting the retainer 434, such as the illustrated cap 442, is required. The cap 442 may be threaded on the housing 412 or retained with fasteners, adhesives, welding, or the like. A spring washer or other compressible device (not shown) may optionally be used between the fitting 434 and the thrusting means as a means of further insuring compression of the tube surfaces. The sealing of this design is accomplished by the outer surface 438 of the barb 436 compressing the tube 414 against the inner seat 432. The fluid experiences very little disruption, with a very cleanable, hygienic fitting 434. The design of the receiving surfaces is preferably done so that the compression of the tube 414 extends very close to the wetted end of the fitting 434 in order to prevent any wetted crevices.

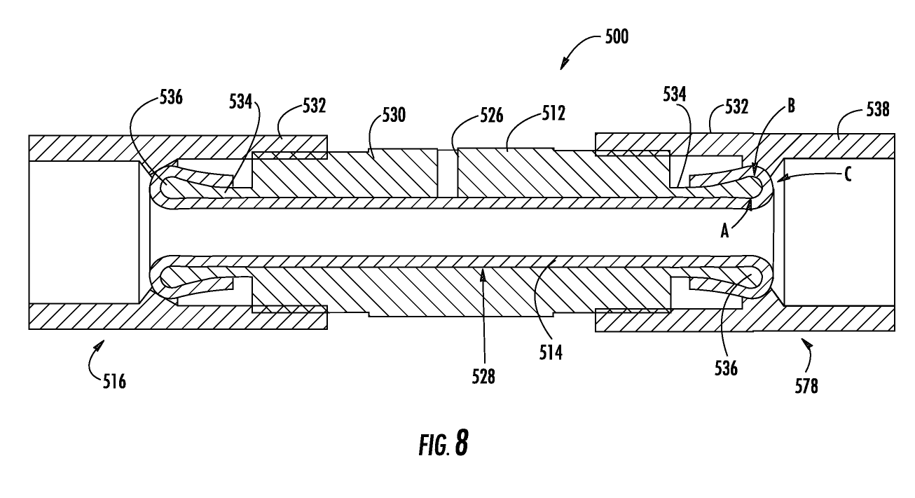

FIG. 8 illustrates yet another exemplary control valve 500 similar in construction to the control valve 200 described above. The control valve 500 includes a housing 512 with an inlet 516 and an outlet 518, a pressure port 526, and an elastomeric tube 514 passing through the housing 512. The outer surface 528 of the tube 514 and the interior of the housing 512 cooperatively define a pressure chamber which is in fluid communication with the pressure port 526. In the illustrated example, the housing 512 includes a barrel 530 and two end fittings 532 which are fabricated separately and joined to the barrel 530 through any suitable means, such as threading, fasteners, a snap-fit, adhesives, thermal or chemical bonding, etc.

Each end of the housing 512 has a generally cylindrical, relatively thin-walled end portion 534 which tapers in thickness to a radiused lip 536 at its distal end. The radiused lip 536 can be considered to be an inner seat for sealing purposes. The end of the tube 514 is folded back over the lip 536 and clamped against the end portion 534 by the end fitting 532. The restraint of the tube 514 is configured so that the tube 514 creates a seal or a portion of a seal at three annular surfaces, namely (1) between the barrel 530 and the outer surface of the tube 514, shown at arrow “A”; (2) between tube 514 and the end fitting 532, shown at arrow “B”, and (3) at an axially-facing plane shown at arrow “C”. In the illustrated example each end fitting 532 has an outer section 538 which is configured to receive a fluid conduit (not shown) such as a pipe, tube, fitting, etc. The end fitting 532 could optionally be constrained by a separate thrust device which would prevent rotation of the end fitting 532 against the tube 514 during tightening. Also, though no air gap is shown between the outer surface of the tube 514 and the inner surface of the barrel 530, such a gap may be optionally provided.

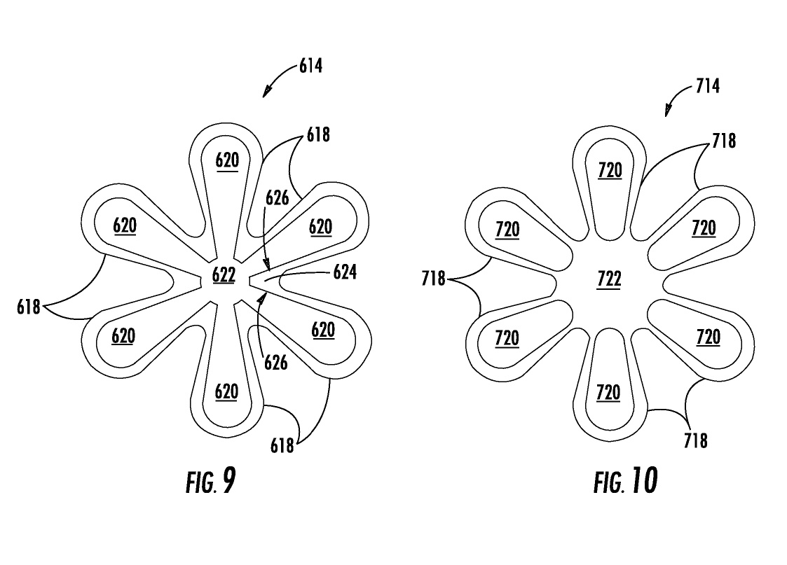

The above examples have described several variations of a control valve with a central elastomeric tube defining a single flow passage. It is also possible to incorporate more than one flow passage into a tube. For example, FIG. 9 illustrates a cross-section of an elongated elastomeric tube 614 which comprises a plurality of radially-extending lobes 618. Each lobe 618 defines an individual flow passage 620. Each of these lobes 618 compresses under pressure to form a constricted “dog-bone” shape as described above. As shown in FIG. 9, The center 622 of the tube 614 is open, and the inner ends of the lobes 618 define a plurality of wedges 624 with side faces 626. In operation, external pressure would cause the wedges to collapse inward with their side faces 626 abutting each other, thus separating the individual flow passages. FIG. 10 shows the cross-section of a similar elastomeric tube 714 with a plurality of radially-extending lobes 718 defining flow passages 720. The center 722 of the tube 714 is solid, so that the flow passages 720 are permanently isolated from each other.

The tubes 614 or 714 may be used to control flow of a several fluid flows simultaneously. The fluids may be the same or different, and each of the lobes 618 or 718 may have its flow characteristics (e.g. cross-sectional area, wall thickness, etc.) tailored separately from the remaining lobes 618 or 718.

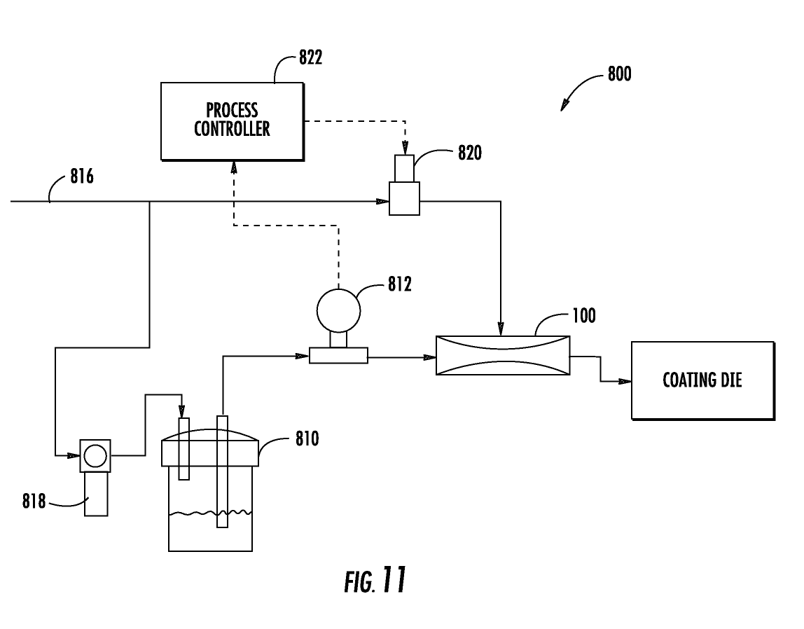

The use of the control valve will now be described. Throughout this description, reference will be made to the control valve 100 as an example, with the understanding that the method is equally applicable to any of the control valves 100, 200, 300, 400, or 500 described above. Aspects of the method of using the control valve 100 include special sizing of the elastomeric tube 114 cross section, providing effective control logic, and increasing control system stability by appropriate system design. For context, FIG. 11 illustrates a fluid system 800 with a pressure pot 810 containing a liquid to be metered, a flowmeter 812, a control valve 100, and a downstream process 814 (such as a coating die). pressurized air or other working fluid is received from a common line 816 and then supplied to the pressure pot 810 through a regulator 818 and to the control valve 100 through a source of controlled fluid pressure, such as an electro-pneumatic regulator 820 (referred to as E/P or I/P for voltage-to-pressure or current-to-pressure respectively). A process controller 822 of a known type, for example including PI or PID functionality, receives flow rate information from the flow meter and supplies control commands to the electro-pneumatic regulator 820. This is but one example of a fluid system which requires accurate, repeatable flow control. It will be understood that the control valve 100 and the methods described herein are suitable for use with many types of fluid systems.

Sizing of the control valve 114 is very important for the most stable control. One way of describing the desired sizing of the control valve 100 is in terms of the valve coefficient or Cv. Cv is a well-known parameter relating flow to the pressure drop across a valve, and is calculated as follows:

$$Cv = F \sqrt{\frac{SG}{Δ P}}$$

Where F=flowrate (GPM); SG=specific gravity; and ΔP=pressure drop (psi) across the valve. Typically, commercially-available valves have a Cv which is calculated under specified conditions. For any specified pressure drop, the control valve 100 with its tube 114 in the relaxed or unconstricted condition will have a maximum flow which results in a maximum computed Cv. The Cv computed under these conditions is analogous to the specified Cv of a commercial valve, and is referred to herein as Cv(max). However, the Cv can be calculated for the actual flowrate through the control valve 100 when the tube 114 is at any desired degree of constriction, including flows much less than the maximum. The ratio of the Cv at a particular flowrate to Cv(max), expressed as Cv/Cv(max), can be used to describe the degree to which the control valve 100 is “oversized” relative to conventional valve sizing practice. Contrary to conventional control valve application and practice, the most stable control occurs less than about 1% Cv/Cv(max), and the most preferable configuration for many applications occurs with Cv/Cv(max) less than about 0.1%. The extension of pinch valves for control at less than 0.1% Cv/Cv(max) is contrary to the expectation and practice of all other control valve technology.

The sizing may also be described directly in terms of dimensions. When expressed this way, the elastomeric tube 114 preferably is sized such that average liquid velocity in the relaxed (unconstricted) tube 114 is less than about 30.5 cm/s (2 ft/s). Most preferred is a sizing to result in an average liquid velocity of about 6.1 cm/s (0.1 ft/s) or less. For example, this latter value would occur in a 6.4 mm (¼ in.) ID tube with a flow of 5 ml/min. In many cases this will also result in the tube 114 having an ID substantially larger than the external tube, pipe, or piping run that the control valve 100 is connected to. For example, referring back to FIG. 4, the control valve 100 is shown with sections 101 of a piping run connected to its inlet 116 and outlet 118. The piping run 101 has an ID, denoted “D1” which is substantially less than the unconstricted (relaxed) ID of the tube 114, denoted “D2”. This relative sizing may be incorporated directly into the control valve 100, for example by providing fittings 134 which taper in inner diameter, as shown. Thus configured, the inlet 116 and outlet 118 each have an inner diameter “D3” which is substantially less than the unconstricted (relaxed) ID of the tube 114. In contrast, when prior art pinch valves are used in the liquid processing industry, they are typically sized such that the ID of the relaxed pinch valve conduit (analogous to the tube 114) is similar to the ID of the rest of the piping system. Typical liquid process systems are designed for liquid flow rates up to and above 152 cm/s (5 ft/s) for polymeric piping systems and up to 244-305 cm/s (8-10 ft/s) for metallic piping systems.

The sizing described herein results in the tube 114 being substantially larger in cross section than air pinch valve conduits used for on-off service for the same liquid flow rate range. It is believed that sizing the elastomeric tube 114 to be relatively large enables valve operation over the required entire dynamic range with the tube 114 essentially in a stable collapsed configuration. This is based on the unexpected discovery that with the elastomeric tube 114 in a collapsed configuration, the flow rate can be precisely controlled down to extremely low flow rates, for example below about 5 ml/min. and down to 0.1 ml/min. and below. By sizing the tube cross section to be relatively large, even a modest applied relative pressure collapses the tube 114 into a stable dog bone configuration as shown in FIG. 2A. This stable collapsed configuration corresponding to high flow at modest applied relative pressure establishes the top of the valve's dynamic range. Further increase in pinch pressure further constricts the two flow passages of the dog bone configuration in a very repeatable, surprisingly high resolution response even down to extremely low flow rate as noted before and as illustrated in FIG. 2B. The so-sized precision elastomeric metering valve is found to possess resolution better than 0.01% across an extremely large dynamic range greater than 10,000:1 (where the percentage resolution is calculated by dividing the minimum controllable flow increment by the total possible dynamic range of flow through the valve). Without the over-sized design approach, prior art attempts to achieve stable flow control in the more uncollapsed geometry (FIG. 2C) typically result in a much more unstable mode. It is nearly impossible for a process controller to control the hypersensitive performance of the tubing once it begins to approach the open-center geometries as shown in 2C.

The method also includes providing effective control logic. Even with the preferred conduit elongation or with proper cross-section sizing, the sensitivity of the flow response to changes in pressure are extremely different from low flow to high flow. When properly sized, the control valve 100 exhibits a sensitivity curve which is highly exponential in nature. A preferred manner of providing control logic is that the control loop (typically a Proportional/Integral algorithm) be programmed with an a gain algorithm, such as a look-up table or other F(X) functionality so that the control valve 100 can automatically respond to a variety of flow set-points without have to be re-tuned. This online adjustment of the controller gain is often referred to as “adaptive gain”. Typical adaptive gain applications present modest fine tuning of gain parameters, such as in a range 50% to 200% of nominal. However, the required adaptation of gain values for this invention can be exponential in nature, very important to good performance, and would be very difficult to arrive at through typical tuning methodologies. A typical example of an adaptive gain curve may exhibit a max/min adaptive gain of 30:1 or more, depending on the dynamic range of the flow rate and the other system components.

A preferred method includes determining the adaptive gain table according to a specific procedure defined as follows. The values for the adaptable gain table can be obtained by testing the control valve 100 in the particular application of interest (same flow, upstream and downstream pressure drop, etc.) and recording the various combinations of pinch pressures and resulting flow rates. The sensitivity of the control valve 100 can be calculated at any setpoint by dividing the change in flow by the change in pinch pressure for surrounding measurements. For example, to obtain the sensitivity for a flow rate of 100 ml/min., measurements would be taken of the pinch pressures required for both 90 ml/min. and 110 ml/min. The sensitivity is the change in flow divided by the change in pinch pressure for these points. The desired adaptable gain values can be obtained by inverting the sensitivity values (i.e. dividing any arbitrary number by the relative sensitivity values for each set point). The arbitrary number is ideally chosen such that the maximum gain multiplier (typically required for the lowest flow rate) is at or near 100%. Once this exponential curve is entered into the controller 822 for the adaptable gain, the loop can be quickly tuned by selecting appropriate Proportional Band and Integral values (derivative only if desired). If the selected controller does not support the adaptable gain feature, then the exponential gain curve can be multiplied by the user-tunable gain and integral values and inserted into the controller 822. It is recommended that the exponential gain curve be applied over both the Proportional Band and the Integral functionality (many known controllers do this automatically). After following this procedure, the system should perform throughout a wide dynamic flow range with a given static gain and integral values.

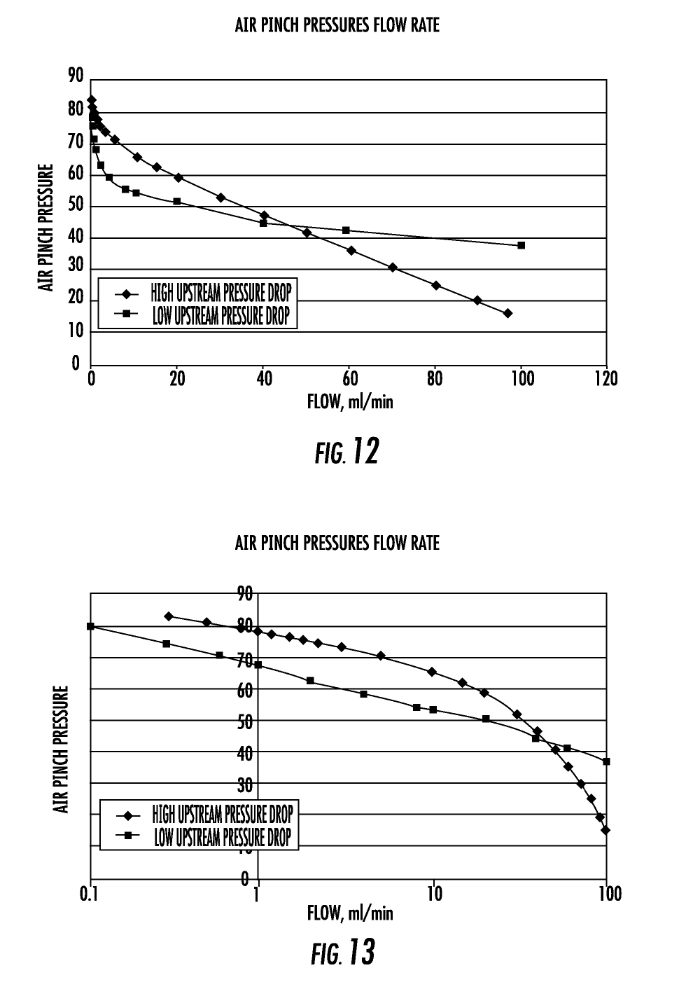

FIG. 12 illustrates a couple of typical curves resulting from the test procedure derived above. The air pinch pressure varies according to a non-linear curve with flow. Curves showing both high and low upstream pressure drop are shown, illustrating the impact system pressure drop has on the performance of the control valve 100. The higher pressure drop curve was obtained by using a Coriolis mass flowmeter with smaller internal tubing diameter than the lower pressure drop curve. FIG. 13 shows a logarithmic plot of FIG. 12. FIG. 14 shows the sensitivity curve obtained by the procedure above with the data taken from FIG. 12.

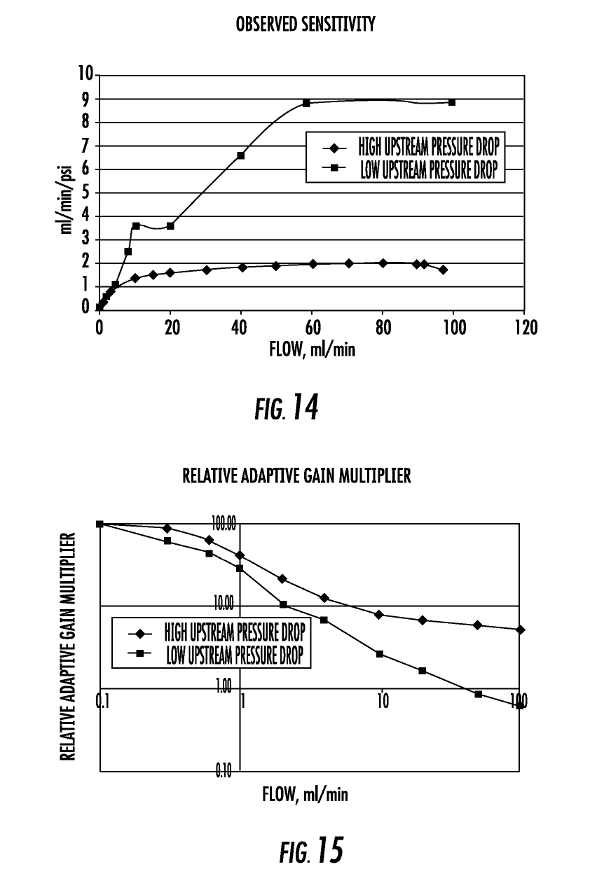

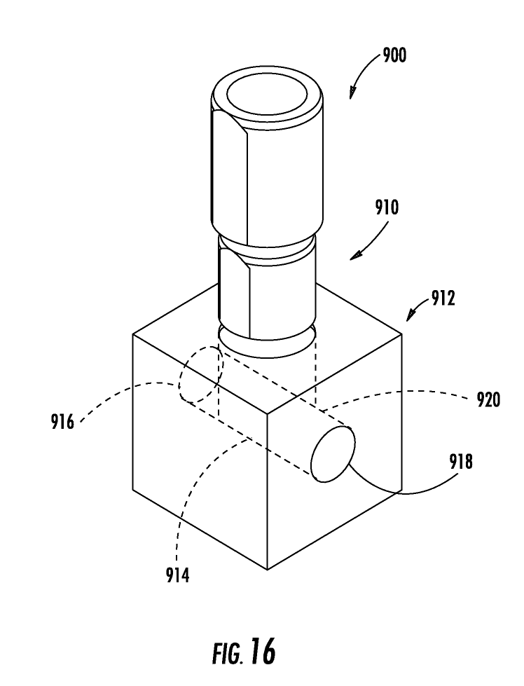

FIG. 15 shows an exemplary recommended gain multiplier from the procedure above. Curve smoothing can be done to address any anomalous bumps in the sensitivity curve that do not appear to result from the exponential factors at play. This curve can be tweaked if desired to further optimize system performance. These figures clearly show that pressure drop upstream of the control valve 100 serves to flatten the sensitivity curve, and thereby lessen the dynamic range of recommended gain multipliers required. This beneficial impact of upstream pressure drop should be taken into account when design a fluid system.

Therefore, for certain types of applications such as flow delivery from a pressure pot, it is recommended that the overall fluid system be designed with relatively high friction pressure drop from the source of fluid pressure (“pressure pot” or pressurized vessel) to the control valve 100. Sources of frictional pressure drop typically include a filter, tubing, flowmeter, etc. The ideal scenario would locate all components that cause a significant frictional loss (except for the control valve 100) upstream of the control valve 100. The beneficial effect continues to increase with increasing frictional contribution, but an adequate margin should be left to allow for changes in viscosity and changes in pressure vessel conditions. If a filter is included in this system, a very significant allowance needs to be made for increasing pressure drop through the filter as it begins to plug. Coriolis flowmeters are one of the very highest precision flow measuring devices available. They are known to have a larger pressure drop in viscous fluid service as compared with other flow meters such as vortex, orifice, or magnetic type. Further, Coriolis flowmeters perform with higher accuracies when they are sized with the smallest tube diameters (high velocities) possible in their permissible range. (Because of the long length/diameter nature of Coriolis flow meters, cavitation is not a concern here). Therefore, it is preferable that a Coriolis meter be sized with the smallest tube diameter allowable for the stated flow range, and while also observing the guidelines mentioned above for overall system pressure drop. A preferred embodiment of this system (where no filter or other significant pressure drop exists other than the flow meter and metering valve) would have a Coriolis flowmeter pressure drop, upstream of the control valve 100, greater than about ⅔ of the total available pressure drop of the system at maximum flow.

The design rules of thumb described above are contrary to the prior art rule of thumb that a control valve should have at least ⅓, and preferably more of the available system pressure drop. Pressure drop downstream of the valve has a destabilizing effect on the system due to hypersensitivity. This is because the Cv of the control valve 100 is a complex function of three pressures: (1) the pinch pressure, (2) the inlet liquid pressure, and (3) the outlet liquid pressure. While the ability of the control valve 100 is primarily defined, as described before, by the differential between the pinch pressure and the liquid inlet pressure, there is a secondary effect whereby lower outlet pressure assists the tube 114 in closing. By placing as much of the pressure drop upstream of the control valve 100 as possible, the control stability is maximized by lessening valve sensitivity to slight pinch pressure changes, and by lessening sensitivity to pressure disruptions in the downstream environment. If the majority of the pressure drop were downstream of the control valve 100, the response curve of pinch pressure versus resulting flow would become steep and actually unstable due to the fact that a temporary increase in flow actually increases valve exit pressure, thereby further opening the control valve 100 (due to the reduction in pinch differential), further increasing flow. This type of feedback system can actually cause undesirable chatter or “water hammer” in systems designed where most of the system friction losses are downstream of the valve.

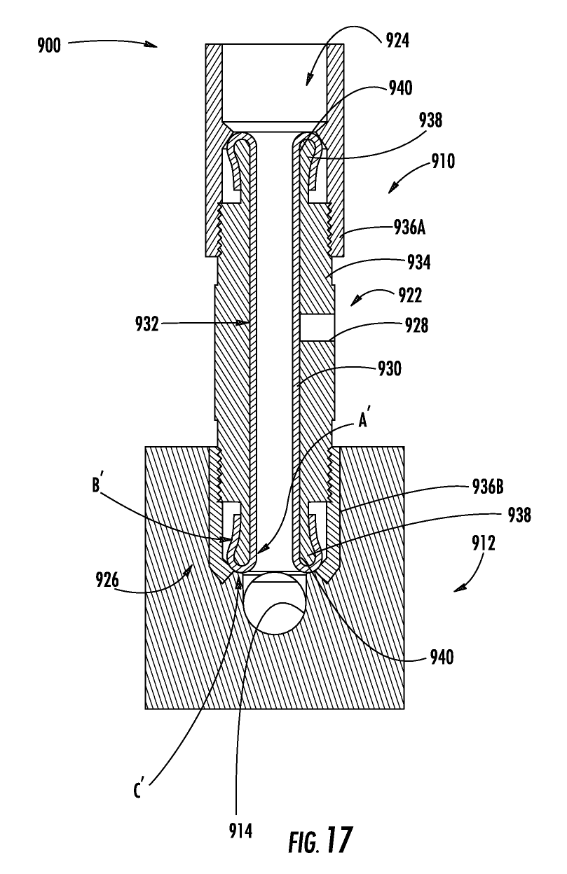

In addition to providing accurate flow metering, some of the variants of the control valve described above are especially useful for serving as an injector, by being fitted directly at the intersection of two fluid flows. For example, FIGS. 16 and 17 illustrate a fluid injector 900 comprising a control valve 910 mounted to a tee block 912. The tee block 912 is a simple unitary structure having a first passage 914 extending through it, with an inlet 916 at one end and an outlet 918 at the other end. A second passage 920 intersects the first passage 914. The first passage 914 is intended to accommodate a first or major fluid stream, while the second passage 920 is intended to flow a second fluid stream, also referred to as a minor fluid stream or “injectant”. The control valve 900 is similar in construction to the control valve 500 described above. It includes a housing 922 with an inlet 924 and an outlet 926, a pressure port 928 and an elastomeric tube 930 passing through the housing 922. The outer surface 932 of the tube 930 and the interior of the housing 922 cooperatively define a pressure chamber which is in fluid communication with the pressure port 928. In the illustrated example, the housing 922 includes a barrel 934 and two end fittings which are fabricated separately and joined to the barrel 934 through any suitable means, such as threading, fasteners, a snap-fit, adhesives, thermal or chemical bonding, etc.

Each end of the housing 922 has a generally cylindrical, relatively thin-walled end portion 938 which tapers in thickness to a radiused lip 940 at its distal end. The end of the tube 930 is folded back over the lip 940 and clamped against the end portion 938 by the end fitting 936. The restraint of the tube 930 is configured so that the tube 930 creates a seal or a portion of a seal at three annular surfaces, namely (1) between the barrel 934 and the outer surface of the tube 930, shown at arrow “A′”; (2) between the tube 930 and the end fitting 936B, shown at arrow “B′”, and (3) at an axially-facing plane. The end fitting 936A has an outer section which is configured to receive a fluid conduit (not shown) such as a pipe, tube, fitting, etc. The other end fitting 936B is designed to accomplish the 3-way seal in the tee block 912, i.e. directly at the intersection between the first and second passages 914 and 920, as shown at arrow “C′”. The seal C′ (i.e. the terminal portion of the tube 930) is within one tube diameter or less from the first passage 914, and preferably directly in contact with the flow area of the first passage 914. With this restraint configuration, the collapsible portion of the tube 930 extends all the way to the end of the radiused lip 940. That is, the collapsible portion terminates within one inner diameter or less from the intersection of the first passage 914 and the second passage 920. Ideally, when the tube 930 is collapsed under air pinch pressure, it closes into a “sphincter-like” configuration at a plane very close to or at the plane C′.

A preferred implementation of this injector 900 is a system wherein the minor fluid or injectant pressure upstream of the control valve 910 is consistently maintained at a higher pressure than the major component stream. Because there are no additional metering or block valves in the system, it is therefore much more predictable that such pressure can always be maintained. The fluid upstream may be supplied by a pressurized vessel, bladder tank, or reliable utility header. A pumped recirculating loop is also an acceptable method of maintaining said constant upstream pressure.

By judiciously selecting the minimum actuation pressure of the control valve 910, it is also possible to prevent any backflow of the major component through the valve in the unexpected event of a loss of pressure in the minor component. For example, if the injectant supply pressure is about 414 kPa (60 psig) and the major component stream is about 134 kPa (20 psig), a typical modulating actuation pressure for the control valve 910 would be in the range of about 483−552 kPa (70-80 psig). By setting the minimum actuation pressure for the control valve 910 at about 310 kPa (45 psig), for example, even in the unexpected event of a injectant system supply failure, the major component would never be able to penetrate the control valve 910.

The second fundamental benefit of this injector 900 is that the pressure reduction affected by the control valve 910 assures that the velocity of the fluid escaping from the control valve 910 is consistently high, even when the flow rate of the injectant is extremely low. For example, if the flow rate of the fluid is only about 40 ml/min. in an approximate 6.4 mm (¼ in.) ID valve (capable of delivering up to about 4,000 ml/min. wide open), the function of the control valve 910 naturally assures that the final pressure drop is achieved at the very downstream section of the elastomeric tube 930, and that the velocity is accelerated in this section so that the pressure drop is affected by a combination of velocity head loss (predictable by Bernoulli's equation) and the friction drag associated with a high velocity fluid in close proximity to the tubing wall. The control valve 910 typically shoots or sprays this stream directly out into the major component stream in such a way that the component mixing is enhanced by the high Reynolds number. It is noted that the Reynolds number that governs the mixing in the tee block 912 is based on taking the velocity term from the fast injectant stream, but takes the diameter of the first passage 914.

By selecting a pinch valve design with a relatively shorter length-to-diameter (L/D) ratio, preferably less than about 8:1, then the expulsion velocities would be higher due to the greater pressures available for the Bernoulli velocity head drop due to the relatively lower viscous drag pressure drop due to the shorter length of collapsed tubing.

It should be noted that the aforementioned injector valve design could be used in a system where a positive displacement pump or other devices control the flow rate of the fluid. All of the previously mentioned benefits apply even if the control valve 910 is not used for flow metering.

The foregoing has described control valves, fluid injectors, flow control systems, and methods for their use. The control valve described herein are capable of precisely and stably controlling flow rate over an extremely large dynamic range. The valve and method described herein have the very unexpected capability of controlling flow in the extremely low flow rate range below about 5 ml/min. and down to about 0.1 ml/min. and below. It is extremely surprising that such performance would be exhibited by a valve capable of also controlling flow in the 5,000 to 10,000 ml/min. range. It is most surprising that the control valve performs with better stability and more predictable sensitivity when being used in this very low flow rate (far from the unstable zone described above). There are very few liquid controls which are capable of controlling liquid flow in this low range. With control of flow rates as low as 0.1 ml/min. and below and as high as 10,000 ml/min., the resultant practical dynamic range of greater than 10,000:1 exceeds conventional control valves by orders of magnitude and this occurs with unexcelled resolution of better than about 0.01%.

The elongated elastomeric tube that characterizes the control valve described herein provides an internal passage wherein the pressure drop necessary to provide flow rate control is accumulated smoothly and gradually along the conduit's elongated flow path length. The liquid velocity necessary to produce this gradually increasing pressure drop correspondingly remains relatively modest throughout the path length and this has several benefits. The maximum shear rate experienced by the passing liquid is significantly lower than that experienced in conventional control valves. Consequently, the inventive control valve is suitable for applications with shear vulnerable liquids such as with latex suspensions.

A further benefit is that liquid pressure will not drop to an excessively low value even at the location of maximum velocity near to the valve exit. Consequently, liquid passing through the control valve will not have the propensity to cavitate in comparison with a prior art control valve. The control valve described herein has many additional advantages related to it being an elastomeric pinch valve. For example, the internal flow path is smooth and does not have crevices and therefore it can be easily cleaned and bubbles may be effectively flushed. It is therefore suitable for hygienic flow applications. Another advantage is that the housing of the valve does not contact the flowing liquid and therefore compatibility of liquid and the housing construction material is not an issue, thus permitting a lower cost valve housing in many applications. A further benefit particular to the control valve described herein is that it can utilize commercially available low-cost tubes made from a variety of elastomeric materials.

While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation, the invention being defined by the claims.

What is claimed is:

1. A method of controlling flow in a fluid system, comprising:
(a) providing a control valve comprising:
(i) a housing having an inlet, an outlet, and a pressure port; and
(ii) a elastomeric tube disposed inside the housing, the tube having a flow passage extending therethrough which is in fluid communication with the inlet and outlet,
(iii) wherein an outer surface of the tube and the housing cooperatively define a pressure chamber which is in fluid communication solely with the pressure port;
(iv) the control valve, when the tube is in a relaxed state, having a maximum valve coefficient at a selected pressure drop across the control valve;
(b) passing pressurized fluid through the flow passage from the inlet to the outlet at the selected pressure drop; and
(c) modulating the flow rate through the flow passage by applying fluid pressure to the pressure chamber through the pressure port so as to deform the tube, the flow rate selected such that the valve coefficient of the control valve in operation is less than about 0.1% of the maximum valve coefficient.

2. The method of claim 1 wherein the volumetric flow rate through the system is modulated to about 5 ml per minute or less.

3. The method of claim 1 wherein the tube is sized such that the maximum flow rate to be controlled would have a mean stream velocity of about 0.1 feet per second or less if passing through the valve in its open or uncompressed state.

4. The method of 1 further comprising maintaining the tube in a stable collapsed cross-sectional shape at all flow rates of the fluid system.

5. The method of claim 1 further comprising connecting one or more frictional components upstream of the control valve such that, at a maximum rated flow rate of the fluid system, the frictional components consume between greater than about ⅔ of a total available fluid pressure of the system.

6. The method of claim 1 further comprising:
(a) controlling the pressure supplied to the pressure port controlled using an electronic controller having at least proportional and integral functions; and
(b) modulating an effective gain and an integral of the controller by reference to an adaptive gain table which has a minimum to maximum ratio great than about 4:1.

7. A control valve comprising:
(a) a housing having an inlet connected, an outlet, and a pressure port, the inlet and outlet having a first inside diameter; and
(b) a elastomeric tube disposed inside the housing, the tube having a flow passage extending therethrough which is in fluid communication with the inlet and outlet;
(c) wherein an outer surface of the tube and the housing cooperatively define a pressure chamber which is in fluid communication solely with the pressure port; and
(d) the flow passage having a second inside diameter which in a rest state is substantially greater than the first inside diameter.

8. A fluid system comprising:
(a) the control valve of claim 7;
(b) a piping run connected to the inlet and outlet of the control valve, the piping run having a mean inside diameter equal to the first diameter; and
(c) a source of controlled fluid pressure connected in flow communication with the pressure port.

9. The fluid system of claim 8 wherein one or more frictional components are provided upstream of the control valve and arranged such that, at a maximum rated flow rate of the fluid system, the frictional components would consume significantly greater than about ⅔ of a total available fluid pressure of the system.

10. The fluid system of claim 8 wherein the fluid pressure supplied to the pressure port is controlled by an electronic controller having at least proportional and integral functions, an effective gain and an integral of the controller being modulated by reference to an adaptive gain table.

11. The fluid system of claim 8 wherein the tube has a ratio of its wall thickness to its interior diameter between about 2 to about 8.

12. The fluid system of claim 11 wherein the tube has a Shore A Durometer value between about 30 and about 90.

13. A control valve, comprising:
(a) a housing having an inlet, an outlet, and a pressure port, the housing having outward-facing inner seats disposed at opposite ends thereof;
(b) a elastomeric tube disposed inside the housing, the tube having a flow passage extending therethrough which is in fluid communication with the inlet and outlet;
(c) wherein an outer surface of the tube and the housing cooperatively define a pressure chamber which is in fluid communication solely with the pressure port; and
(d) means for compressing the tube against the sealing surface so as to isolate the pressure chamber from flow communication with an exterior environment except through the pressure port.

14. The control valve of claim 13 wherein the means for compressing the tube comprise:
(a) a resilient annular member surrounding the tube and abutting the inner seat; and
(b) an outer retainer disposed against the resilient annular member.

15. The control valve of claim 14 further comprising a rigid ferrule disposed inside the tube and axially aligned with the resilient annular member.

16. The control valve of claim 13 wherein the inner seat has a conical surface, and wherein the means for compressing the tube comprise:
(a) a ferrule received inside the flow passage adjacent the first end of the valve housing, the ferrule having a convex-configured outer surface; and
(b) means for thrusting the ferrule axially against the inner seat.

17. The control valve of claim 16 further comprising a retainer having an inward-facing outer seat disposed against the ferrule.

18. The control valve of claim 13 wherein the inner seat has a conical surface, and wherein the means for compressing the tube comprise:
(a) a fitting which includes a barb received inside the flow passage adjacent the first end of the valve housing, the barb having a convex-configured outer surface; and
(b) means for thrusting the fitting axially against the housing.

19. The control valve of claim 13 wherein:
(a) the housing has an axially-extending end portion including a radiused lip which defines the inner seat; and
(b) wherein the means for compressing the tube comprise an end of the tube which is folded over the radiused lip and clamped against the end portion.

20. A fluid injector comprising:
(a) a tee block having intersecting first and second flow passages therein; and
(b) a control valve connected in fluid communication with the second passage, the control valve including:
(i) a rigid housing; and
(ii) an elastomeric tube disposed inside the housing, the tube having a flow passage extending therethrough disposed in fluid communication with the second passage, wherein a collapsible portion of the tube terminates at a position within about 1 inner diameter of the tube or less from an intersection between the two passages.

21. The fluid injector of claim 20 wherein the tube defines a sealing surface which is positioned to directly contact fluid in the first passage.

22. The fluid injector of claim 20 wherein:
(a) the housing has an axially-extending end portion including a radiused lip which defines the inner seat; and
(b) the end of the tube is folded over the radiused lip and clamped against the end portion.

23. A control valve, comprising:
(a) a housing having an inlet, an outlet, and a pressure port; and
(b) a elastomeric tube disposed inside the housing, the tube having a flow passage extending therethrough which is in fluid communication with the inlet and outlet, and having a cross-sectional shape comprising a plurality of radially-extending lobes;
(c) wherein an outer surface of the tube and the housing cooperatively define a cavity which is in fluid communication solely with the pressure port.

24. The control valve of claim 23 in which a central portion of the tube has a cross-section which is open in a relaxed (unconstricted) state.

25. The control valve of claim 23 in which a central portion of the tube has a solid cross-section.
